(19) United States
(12) Patent Application Publication
(10) Pub. No.: US 2009/0187460 A1
(43) Pub. Date: Jul. 23, 2009

(54) SYSTEM AND METHOD FOR REAL-TIME FEEDBACK

(75) Inventors: Prash Pavagadhi, Oldsmar, FL (US); Rajeev Ratra, Apollo Beach, FL (US)

Correspondence Address: LARSON AND LARSON, 11199 69TH STREET NORTH, LARGO, FL, 33773, US

(73) Assignee: YOUR FAST TRACK, INC., D/B/A QUALITICK, Tampa, FL (US)

(21) Appl. No.: 11/961,277

(22) Filed: Jan. 23, 2008

(51) Int. Cl. G06Q 30/00

(52) U.S. Cl. 705/10

(57) ABSTRACT

An application for a computer system for obtaining feedback at a location of service includes at least one touch screen computer terminal device located at the location of service and software. One computer software module is for authoring a survey, the survey comprising a plurality of survey question with at least one of the survey questions having an answer value configured to trigger a notification signal. Another computer software module presents the survey at the touch screen computer terminal(s) and for obtaining respondent answers to the survey questions and another computer software module monitors the respondent answers and if any of the respondent answers have the answer value configured to trigger the notification signal, the computer software module that monitors the respondent answers triggers the notification signal.

### FIELD OF THE INVENTION

This invention relates to the field of information gathering and more particularly to a system for survey generation with immediate notification capabilities.

### BACKGROUND OF THE INVENTION

Organizations and professionals need to know what they are doing well and what they are doing wrong in order to improve their services and effectively compete in today's information age. Having the right information in the right hands at the right time is critical in making informed decisions. A business that understands their customer's experience is far better equipped to make informed changes that result in improved customer satisfaction, cost savings and employee satisfaction. Customers often feel better about any issues when provided an opportunity to voice their concerns.

To a business, proper feedback and action will result in a significant competitive edge, improved business performance, a better understanding of the market, making it difficult for competitors to enter the marketplace. To a customer, providing an efficient path for feedback will make them feel like part of the organization, able to effect change, and will allow them to vent when things don't go right.

Prior attempts to obtain information include survey cards (either mailed or available in the office), phone surveys and email surveys, etc. Such systems are expensive requiring staff to make calls, transcribe data, etc. Additionally, there is often a great time-lag between the service and completion of the survey. This time-lag leads to a loss of information because the customer (patient) has forgotten details of their experience. This time-lag also leads to a loss of interest on behalf of the customer (patient), often resulting in meaningless data or in the survey not being returned. The time-lag also provides a delay in taking any actions that may improve the situation.

These prior attempts also suffer from sampling frequency issues, in that, due to the resources required to effectively administer such a survey, surveys are only conducted for a short period of time to a cross-section of customers (patients). Although statistics applied to such a survey will indicate validity factors, it would be far better to approach a 100% survey rate. Not only will data accuracy increase, but the customers (patients) will feel better having a way to provide feedback.

All of this is further compounded by the inability to evaluate the data in various ways depending upon the organization. For example, a doctor needs to see how well he/she communicates, etc. A receptionist needs to see how courteous he/she is, etc. A scheduler needs to understand how long people have to wait and how much wait is acceptable, etc. Each different group within an organization needs different slices of the data in a format that they can understand and act upon. A report printed weeks ago with data gathered months ago is no longer sufficient.

Another issue with the prior systems is the ability to update or change surveys and reporting methods. In these, a survey was created/designed (internally or by a 3^{rd}-party) then administered (mailed, phone calls, email, etc.). After the survey period, the data is transcribed then evaluated, usually by a 3^{rd}-party. The printed results are then delivered to those who are in a position to effect change and make improvements. Due to this long cycle, it is almost impossible to recognize a question in need of change until the data is already collected. Furthermore, it is often a person in the IT organization that is responsible for creating the survey and/or modifying the survey, not a decision maker who has a vested interest in the data being gathered.

None of the existing information gathering tools include a way to get instant notification of a severe problem. For example, if a survey question includes an answer that indicates that the customer is very unhappy and will never return and a customer selects that answer, they are out of the office long before any staff is aware of their issue. There is no way for staff to approach that customer (patient) before they leave the office or building since the staff is not informed by the survey until days, weeks or months after the incident occurred. This further weakens the value of the data because the staff that led to the issue often have little or no memory of their interactions with the patient after such a long time period has passed.

U.S. Pat. No. 6,912,251 to Kraft, et al, describes a system for initiating, conducting and managing a survey in real time over a computer network. This patent deals with survey takers who are on the Internet, not at the location of the service. Furthermore, this patent does not provide a real-time notification of specific survey events.

U.S. Pat. No. 6,380,928 to Todd describes a portable survey and satisfaction questionnaire device for the hospitality/restaurant industry. This patent describes a device capable of being used as a survey input system, but does not provide features of data filtering, immediate update of surveys and notification of details when one or more answers indicate an issue.

Additionally, these prior attempts include data gathering periods, then time for data entry, report generation, etc. The added time delays the formulation and introduction of changes in the organization to improve where needed.

What is needed is a survey system that will allow immediate modifications and instantly notify users of issues.

### SUMMARY OF THE INVENTION

In one embodiment, a method of obtaining feedback at a location of service is disclosed including providing a computer terminal device located at a location of service and presenting a plurality of survey questions at the computer terminal device. At least one of the survey questions has an answer value configured to trigger a notification signal. The method includes inputting at least one response to the survey questions at the computer terminal device and, if any one of the at least one responses includes the answer value configured to trigger the notification signal, generating the notification signal.

In another embodiment, a method of obtaining feedback at a location of service is disclosed including providing a touch screen computer terminal device located at a location of service and presenting a plurality of survey questions at the computer terminal device. At least one of the survey questions has a way to trigger a notification signal responsive to an answer to the survey question. Also included is inputting at least one response to the at least one survey question at the touch screen computer terminal device.

In another embodiment, a computer system for obtaining feedback at a location of service is disclosed including at least one touch screen computer terminal device located at the location of service and software. One computer software module is for authoring a survey, the survey comprising a plurality of survey questions with at least one of the survey questions having an answer value configured to trigger a notification signal. Another computer software module presents the survey at the touch screen computer terminal(s) and for obtaining respondent answers to the survey questions and another computer software module monitors the respondent answers and if any of the respondent answers have the answer value configured to trigger the notification signal, the computer software module that monitors the respondent answers triggers the notification signal.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates an elevational view of a system of the present invention.

FIG. 2 illustrates a schematic view of a system of the present invention.

FIG. 3 illustrates a schematic view of a system of the present invention.

FIG. 4 illustrates a sample user interface screen of the present invention.

FIG. 5 illustrates a second sample user interface screen of the present invention.

FIG. 6 illustrates a sample user account interface screen of the present invention.

FIG. 7 illustrates a sample user account interface screen of the present invention with data.

FIG. 8 illustrates a sample survey question creation user interface screen of the present invention.

FIG. 9 illustrates a sample survey question creation user interface screen of the present invention with data.

FIG. 10 illustrates a sample report generator user interface screen for controlling the presentation of data of the present invention.

FIG. 11 illustrates a sample report generator user interface screen for selecting data from a specific terminal of the present invention.

FIG. 12 illustrates a sample report generator user interface screen for selecting data from a date range of the present invention.

FIG. 13 illustrates a sample report generator user interface screen for selecting data with specific attributes of the present invention.

FIG. 14 illustrates a sample notification generator user interface screen for selecting specific questionnaire date that will invoke a notification of the present invention.

FIG. 15 illustrates a sample notification generator user interface screen for selecting specific questionnaire date that will invoke a notification of the present invention with data.

FIG. 16 illustrates a flow chart of the use of the present invention.

FIG. 17 illustrates a flow chart of the notification process of the present invention.

FIG. 18 illustrates a flow chart of the survey creation process of the present invention.

FIG. 19 illustrates a flow chart of the survey filter creation process of the present invention.

FIG. 20 illustrates a schematic diagram of a computer system of the present invention.

FIG. 21 illustrates a schematic diagram of a network system of the present invention.

FIG. 22 illustrates a sample data export user interface screen of the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

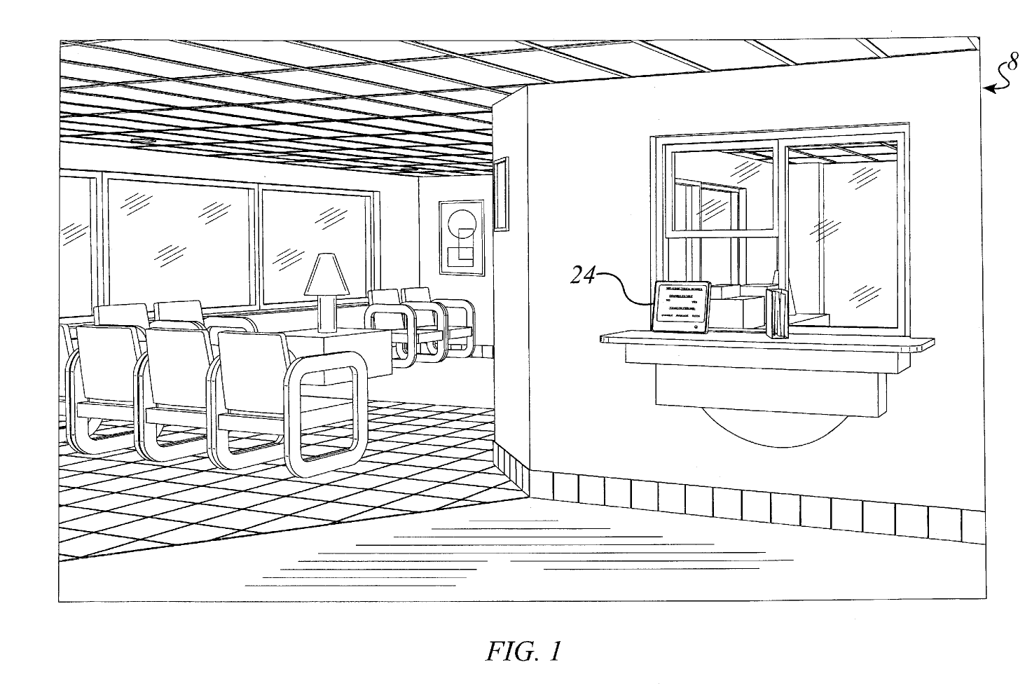

Referring to FIG. 1, an elevational view of a system of the present invention is shown. Although the present invention works in many situations (e.g., locations of service), improving the operation of almost any service, it is best to describe the present invention's operation with respect to a specific use, for example in a doctor's office. A doctor's office 8 is shown in FIG. 1. On the counter is a computer display with a touch screen 24 for presenting surveys and receiving responses from a patient. Although shown on a counter, the display with touch screen 24 is positioned in other locations within the doctor's office 8 in alternate embodiments. It is best to position the display with touch screen 24 in a location where the patient will see it after they receive the service and where the patient will feel they can candidly answer the survey without staff watching. Although shown as a display with touch screen 24, any type of display/data input device is anticipated including PDAs, terminals with keyboards and/or mice, cell phones and the like. It is preferred to obtain feedback at the display with touch screen 24 shortly after the patient receives the service while details of their activities are still fresh in their minds.

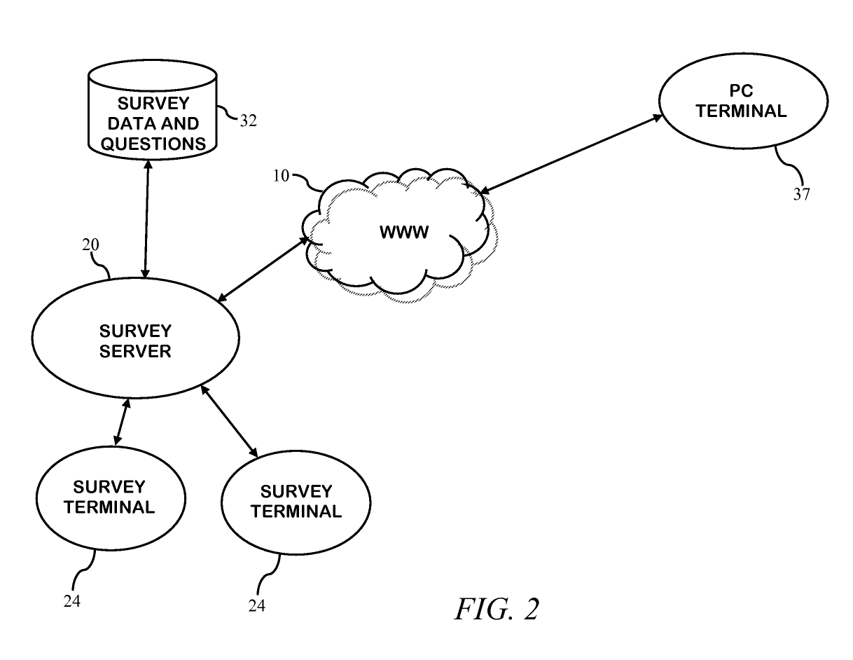

Referring to FIG. 2, a schematic view of a system of the present invention is shown. Although many network layouts are possible, it is preferred to network the survey terminals or personal computers 24 to a server 20. In some embodiments, the survey terminals 24 are networked to the survey server 20 through the Internet 10. The survey server 20 has a database for storing survey data and questions (e.g., surveys) 32. In the preferred embodiment, remote access at a personal computer 37 is provided to the survey server 20 either through the Internet 10, through a direct connection (not shown) or on a local area network (not shown). The remote access personal computer 37 is used, for example, to create and modify surveys, to manage the survey process and to read/print survey results.

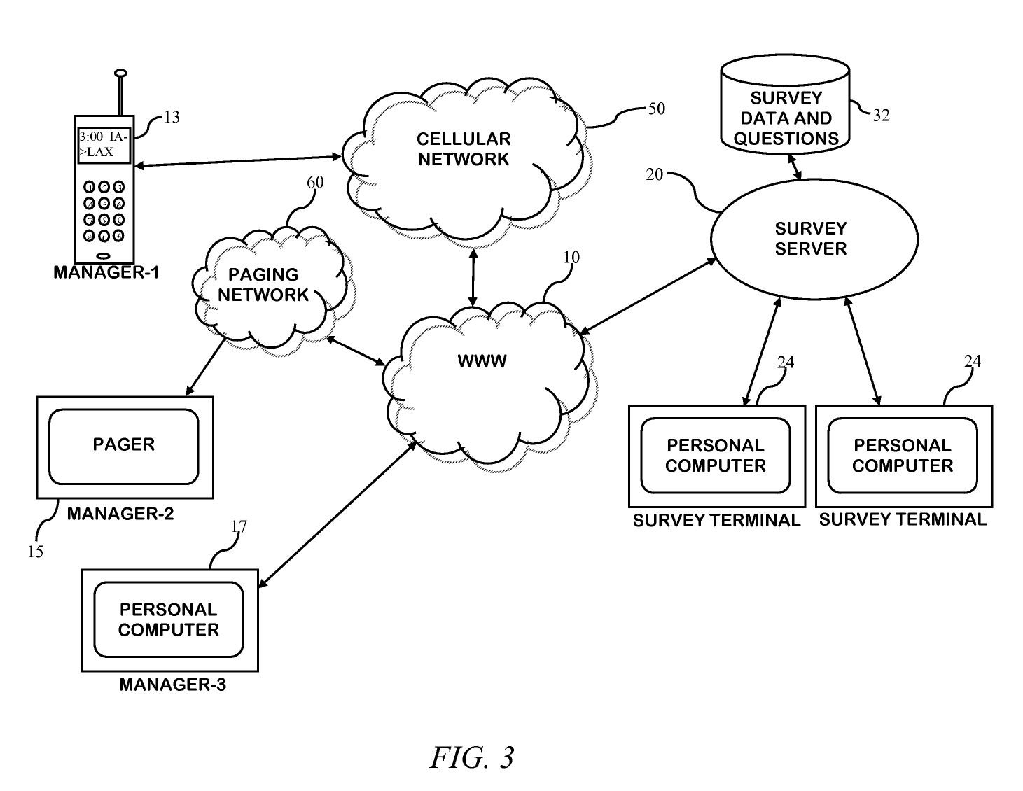

Referring to FIG. 3, a schematic view of a system of the present invention is shown. The survey server 20 has a database for storing survey data and questions (e.g., surveys) 32. One or more survey terminals 24 are connected to the survey server 20 through a direct connection, through a local area network or through a wide area network such as the Internet 10. Although the survey terminals 20 are any terminal or personal computer, a touch screen device is preferred. It is envisioned that the survey terminal(s) 20 will be located in a lobby or lounge area where they are readily accessible to those who are candidates for providing feedback through surveys.

In the preferred embodiment, remote access at a personal computer 37 is provided to the survey server 20 either through the Internet 10 (see FIG. 2), through a direct connection (not shown) or on a local area network (not shown). The remote access personal computer 37 is used, for example, to create and modify surveys, to manage the survey process and to read/print survey results.

As will be described, when certain answers to a given survey are captured, a notification signal is activated. This notification signal is, for example, in response to an answer to one or more questions that indicate the respondent is very unhappy with the service they just received. The notification signal is processed, as will be described, resulting in a near real-time notification to one or more users of the survey system 20. As will be described, each member indicates to the survey system their preferred method of notification (e.g., email, text message, voice message, page) and the address of their device (e.g., phone number, pager number, email address). In response to the notification signal, the survey system 20 determines which member(s) need to receive notification and sends a notification by the predetermined method for each of the member(s).

If the user is configured to receive notices by email, the notification is sent through the Internet 10 (or local area network) to the user's personal computer 17 or other email device as known in the industry. If the user is configured to receive notices by pager, the notification is sent through the Internet 10 through the paging network 60 to the user's pager 15 as known in the industry. If the user is configured to receive notices by text message, the text message notification is sent through the Internet 10 through the cellular network 50 to the user's cell phone 13 as known in the industry. If the user is configured to receive notices by voice message, the notification message is converted to speech as known in the industry and is sent through the Internet 10 through the cellular network 50 to the user's cell phone 13 as known in the industry (voice over Internet Protocol). It is envisioned that other methods of notification as known in the industry work equally as well and are included here within. For example, the notification message is converted into an audio file and a phone connection is made between the survey system 10 and any telephone and, on connection to the telephone, the audio file is played.

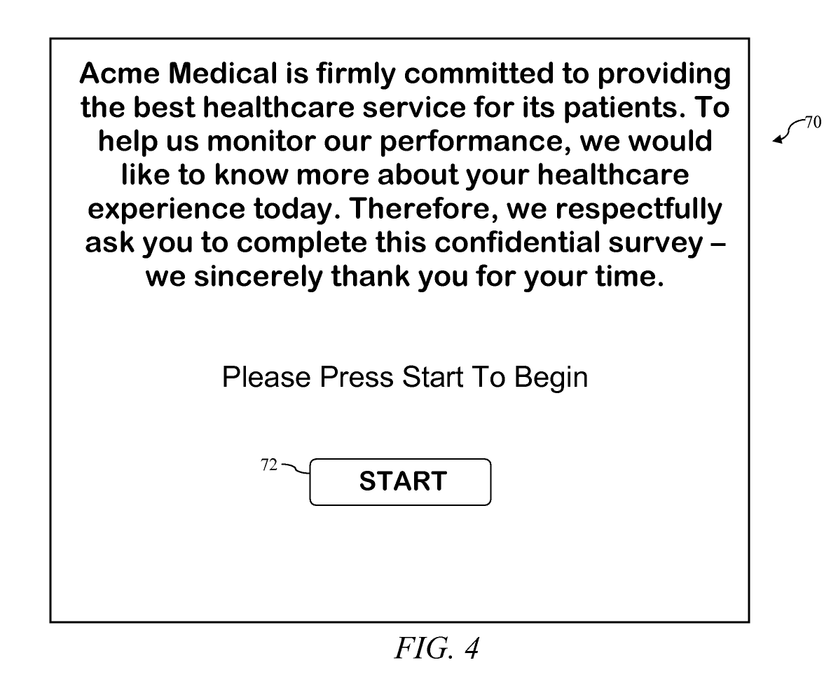

Referring to FIG. 4, a sample user interface screen of the present invention is shown. This is a sample user interface screen 70 presented on a touch screen inviting the customer (patient) to respond to the survey. The customer (patient) touches the screen in the area of the “Start” button icon 72 to proceed with the survey.

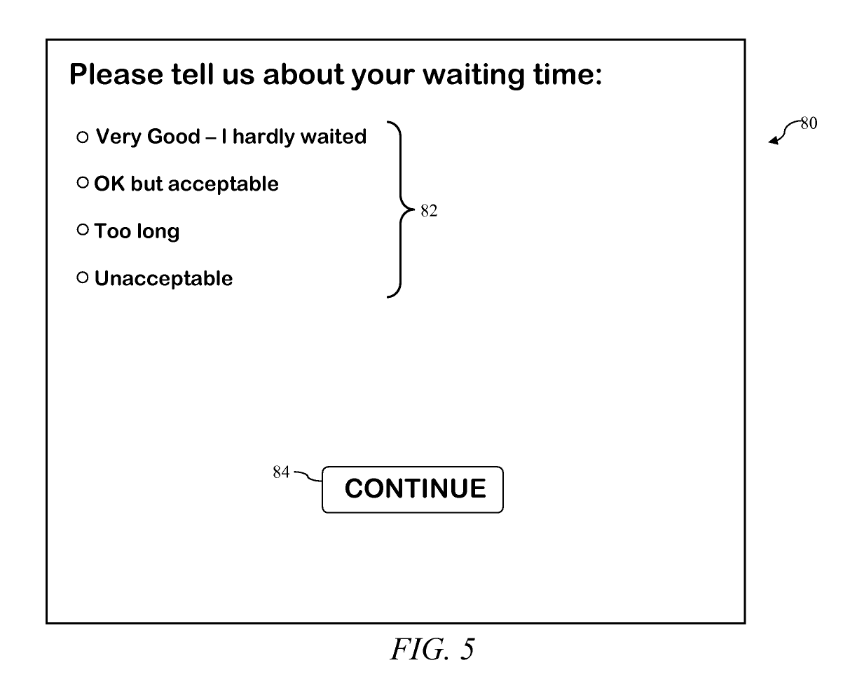

Referring to FIG. 5, a second sample user interface screen of the present invention is shown. This user interface screen 80 is a sample of a question that has four multiple choices 82. The customer (patient) selects one choice by touching that choice then touches the “Continue” button icon 84 to proceed to the next question (or finish the survey).

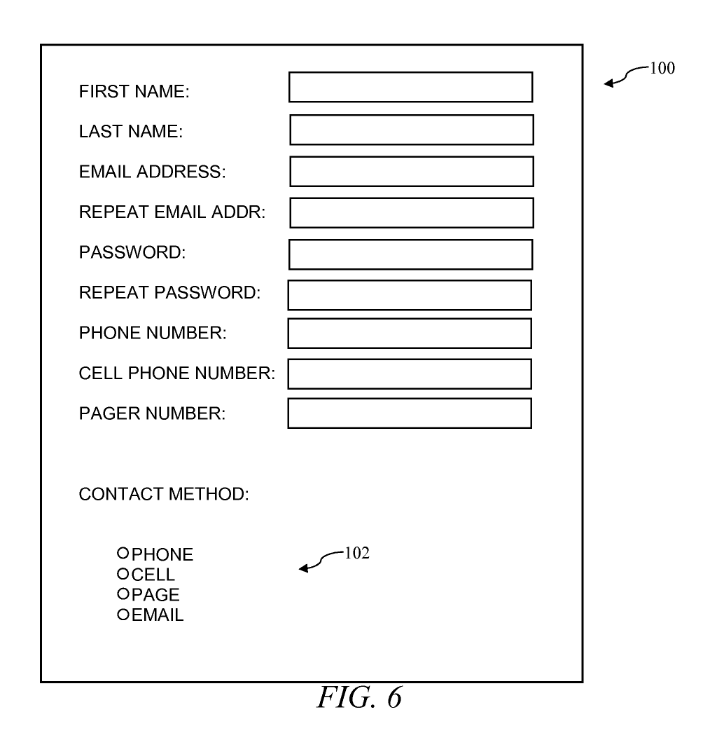

Referring to FIG. 6, a sample user account interface screen of the present invention is shown. In this typical user interface 100, the new user enters, for example, their name (first and last), email address, confirmation of email address, password, confirmation of password, phone number, cell phone number and pager number. The same or similar user interface is presented when the member needs to change/update any of their personal information. The bottom of this user interface 100 has four radio buttons 102 (circles that darken when selected) for the preferred method of contact (phone, cell, pager or email). The member selects one or more of these radio buttons 102, thereby a darkened circle indicates the member will receive notifications of events by the means associated with the darkened button. To restore the radio button 102 to its original non-selected state, it is selected again. Many user interface paradigms are known in the industry for obtaining user information and the example shown is just one possible user interface. All known user interfaces for obtaining user data and preferences are included in the present invention.

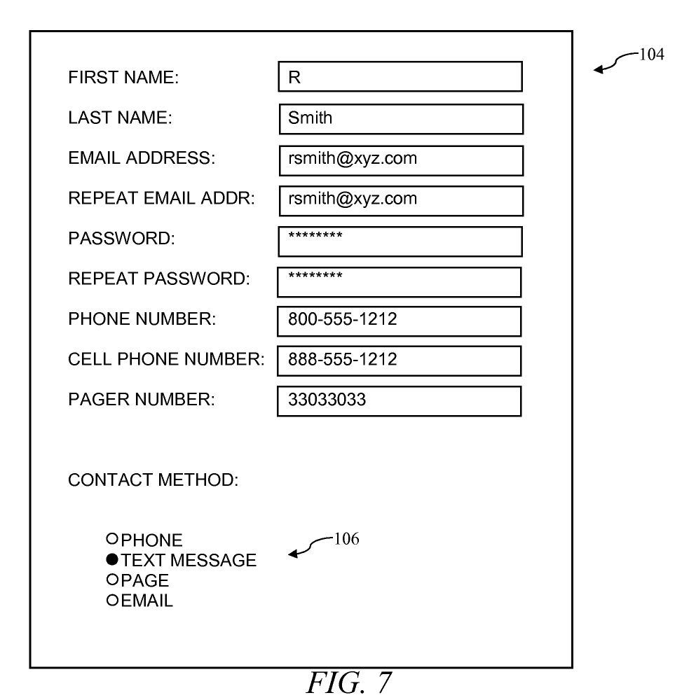

Referring to FIG. 7, a sample user account interface screen of the present invention with data is shown. In this typical user interface 104, the new user entered their name (R. Smith), email address (rsmith@xyz.com), confirmation of email address (rsmith@xyz.com), password (not visible ********), confirmation of password (not visible), phone number (800-555-1212), cell phone number (888-555-1212) and pager number (33033033). The four radio buttons 106 at the bottom of this user interface 104 show that the user (R. Smith) has selected to receive notifications by text message (circle for “Text Message” darkened). This member will receive notifications of events by text message when a survey question is answered according to set filters. Many user interface paradigms are known in the industry for obtaining user information and the example shown is just one possible user interface. All known user interfaces for obtaining user data and preferences are included in the present invention.

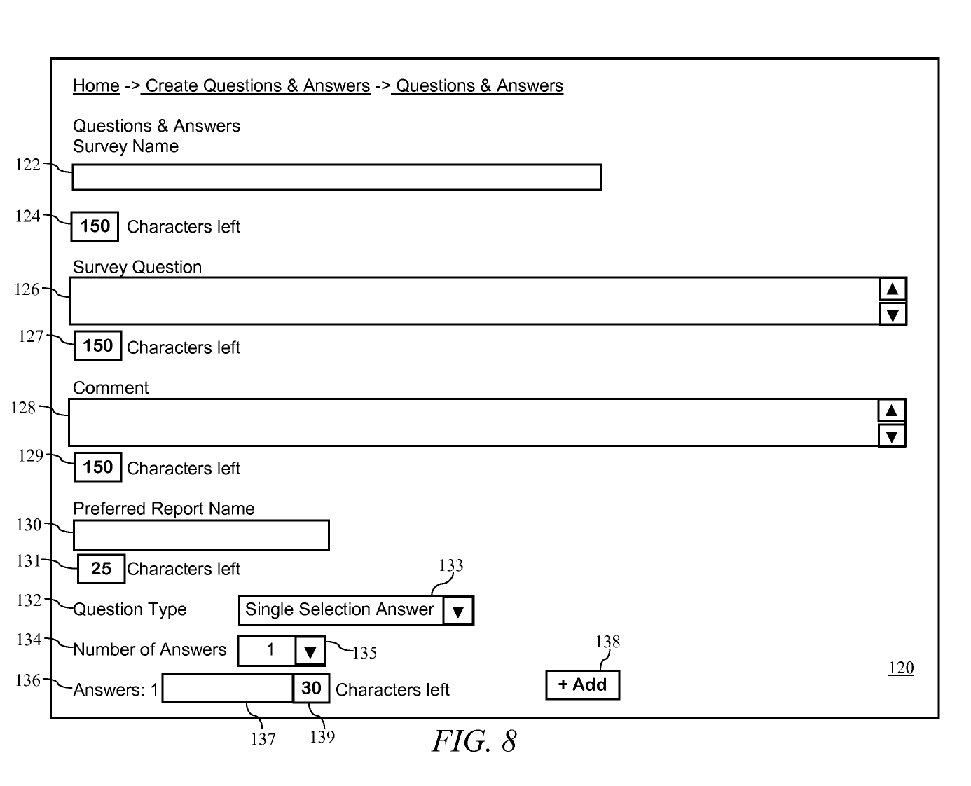

Referring to FIG. 8, a sample survey question creation user interface screen of the present invention is shown. In order for the survey system 20 to be useful in any sized organization, it must be easy to create and modify surveys. The survey question creation tool presents a survey question creation screen 120, allowing the user/administrator to create survey questions one at a time. In this exemplary user interface, the survey question creation screen 120 has a field for the name of the survey 122, the survey question 126, a comment regarding the question 128, a report name 130, the question type 133 (e.g., single selection answer, free-format, etc.), the number of answers 135 and the answers 136. There are many ways to specify the answers. For example, selecting the number of answers of 4 using the pull down selector 135 results in a screen requesting answer 1 in the input field 137. After selecting the “Add” button icon 138, a screen requesting answer 2 in the input field 137 is displayed, and so forth. For fields with limited space, characters left boxes 124/127/129/131/139 are provided to indicate how many more characters are allowable in their associated fields 122/126/128/130/137.

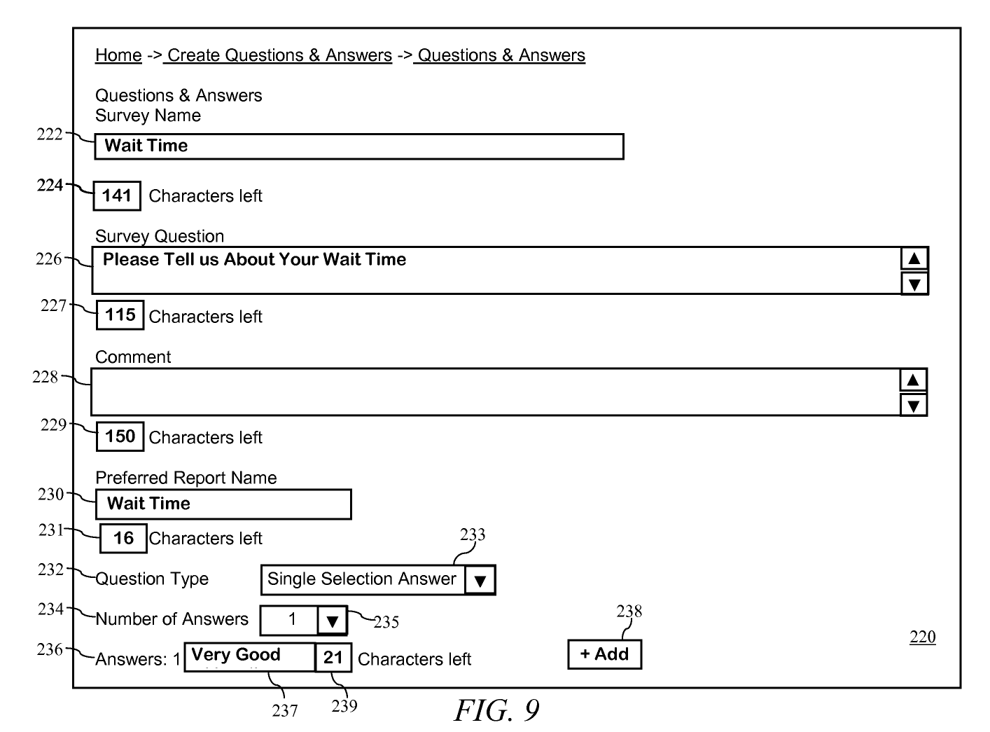

Referring to FIG. 9, a sample survey question creation user interface screen of the present invention with data is shown. In this exemplary user interface 220, the user has entered “Wait Time” in the name of the survey 222 and “Please Tell us About Your Wait Time” in the survey question 226. No comments were entered regarding the question 228. A report name 230 is “Wait Time.” The question type 232 is single selection answer 233 and the number of answers 234 is set to one 235. The first answer 236 is set to “Very Good” 137. Note how the characters left boxes 224/227/229/231/239 have been updated to indicate how many more characters are allowable in their associated fields 222/226/228/230/237.

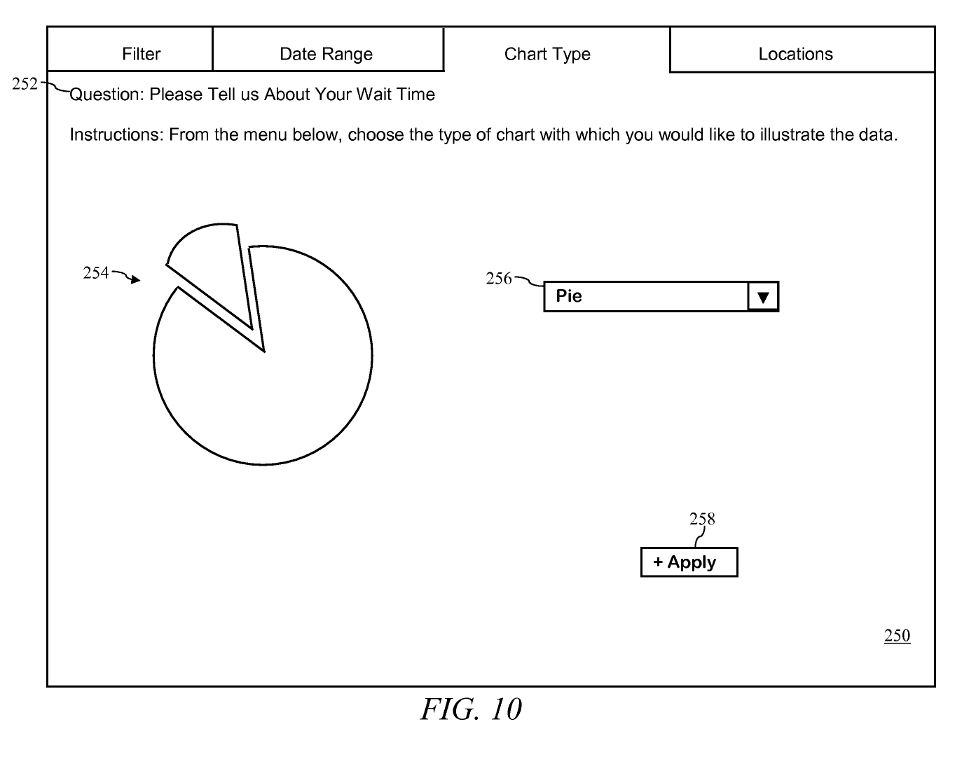

Referring to FIG. 10, a sample report generator user interface screen for controlling the presentation of data of the present invention is shown. The report generator permits the user to specify how the results of each survey questionnaire are displayed in the report. The user is allowed to filter the data (e.g., use results from surveys where female is selected in the question of gender), select a date range (when the survey was completed), display the results in specific formats (e.g., pie charts, bar graphs, etc.) and select survey data from a particular survey terminal.

In the report generator chart type user interface 250, the user is shown the question 252 and selects the display type from, for example, a pull-down list 256 of possible display options. In some embodiment, a sample of the display 254 is shown for help purposes. Once finished selecting the chart type, the user selects the “Apply” button icon 258 to accept the chart type and proceed.

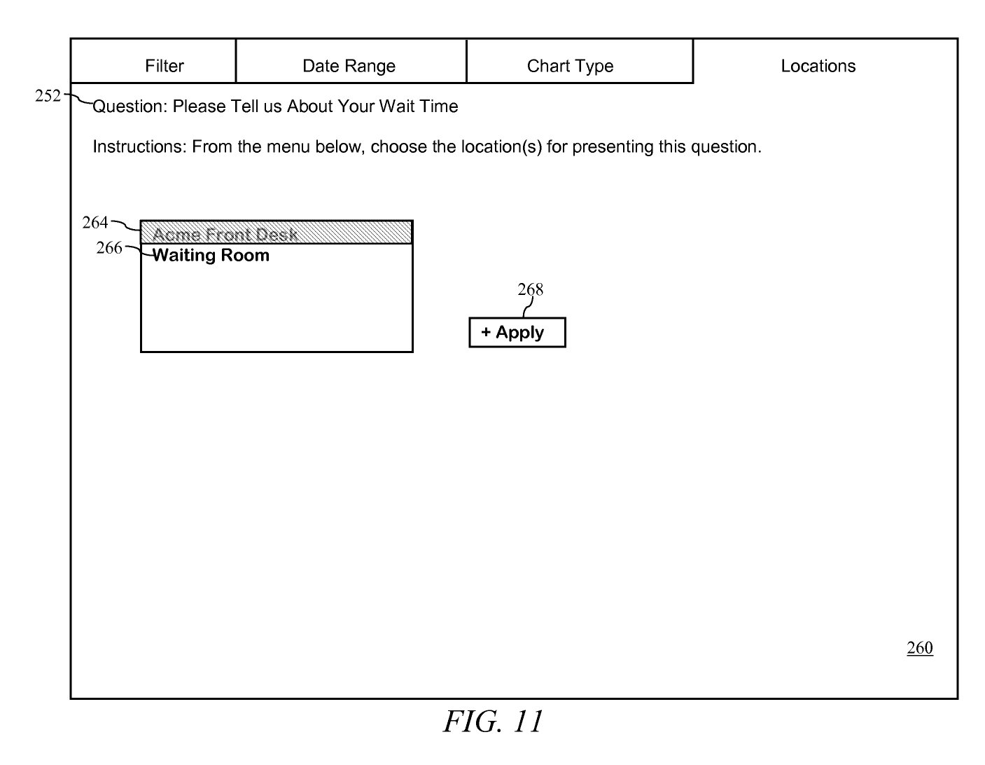

Referring to FIG. 11, a sample report generator user interface screen for selecting data from a specific terminal or location of service of the present invention is shown. This exemplary user interface 260 provides a facility for the user/administrator to select one or more survey terminals 24 from which data will be analyzed. The user/administrator is shown the survey question 252 and locations of individual survey terminals 264/266. In this example, the location of service at the Acme Front Desk survey terminal 264 is highlighted (selected) and the Waiting Room survey terminal 266 is not selected. Therefore, the reports generated will contain data from the Acme Front Desk survey terminal 264 (location of service) and will not contain data from the Waiting Room survey terminal 266. Once selections are made, the “Apply” button icon 268 is selected. Other user interface methods of selecting specific input terminals are anticipated as known in the industry such as radio buttons, pull-down lists, etc.

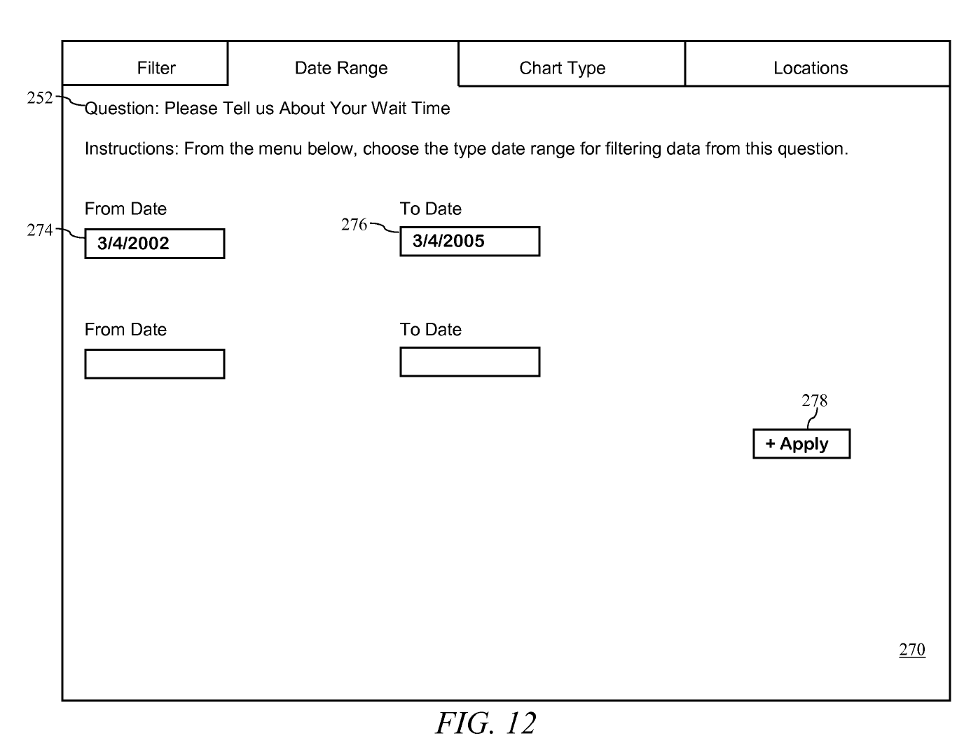

Referring to FIG. 12, a sample report generator user interface screen for selecting data from a date range of the present invention is shown. This exemplary user interface 270 provides a facility for the user/administrator to select a range of dates on which to report. The user/administrator is shown the survey question 252 and one or more sets of date range fields 274/276 to specify a range of dates on which to report. In the example shown, the reports will reflect surveys completed between (from) 3/4/2002 274 and (to) 3/4/2005 276. Note, in some embodiments, multiple date range fields 274/276 are provided. This allows the user/administrator to specify multiple ranges such as 1/1/07 to 1/31/07 and 6/1/07 to 6/31/07. Once selections are made, the “Apply” button icon 278 is selected. Other user interface methods of selecting specific input terminals are anticipated as known in the industry such as free-text fields, calendars, etc.

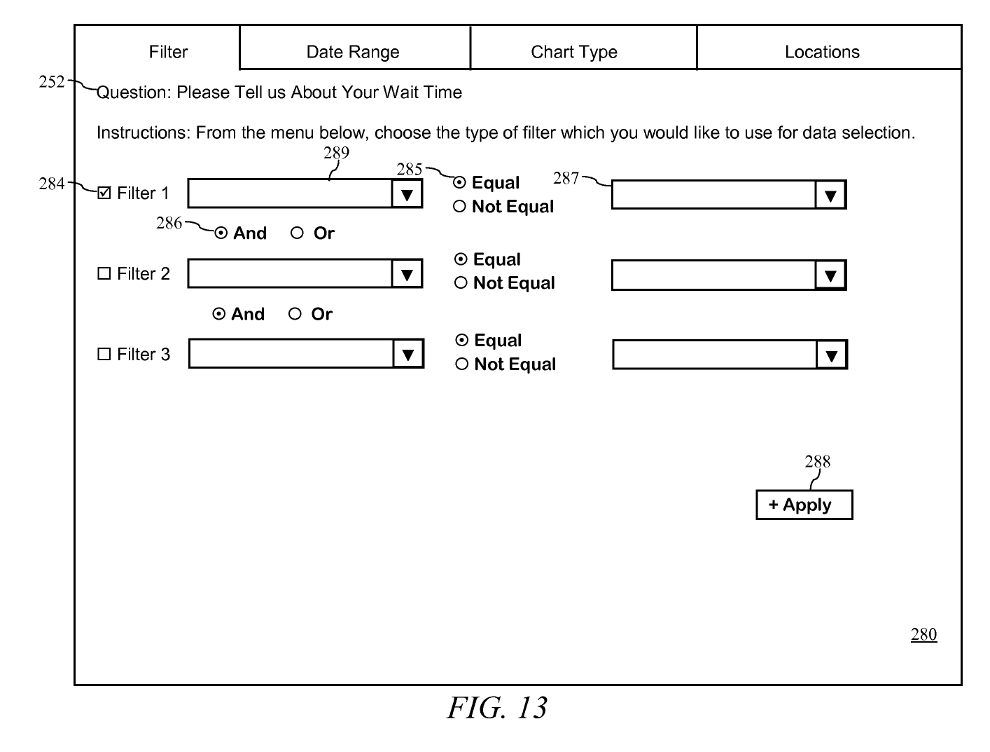

Referring to FIG. 13, a sample report generator user interface screen for selecting data with specific attributes of the present invention is shown. This exemplary user interface 280 provides a facility for the user/administrator to select survey responses with specific data in specific fields. The user/administrator is shown the survey question 252. In this example, a first filter is enabled by checking the box 284 at its left. Then the answer field 289 is set to the answer of interest, for example, “Gender” and the compare operator 285 is set as desired (equal) and the value field 287 is set to the value desired, for example, “Female.” In this example, the survey report will contain responses from everybody who completed the survey indicating they were female. If more than one filter is enabled, the filters are connected by Boolean operators 286 allowing the user/administrator to generate filters that are more complicated such as “all respondents that are female and all respondents that are over 50 years old” and “all respondents that are between 20 and 30 years old and all respondents that are over 60 years old.” Once finished creating the filter, the user/administrator selects the “Apply” button/icon to enable the filter. Other user interface methods of selecting filters are anticipated as known in the industry such as free-text filters, other operators (less than, greater than), etc.

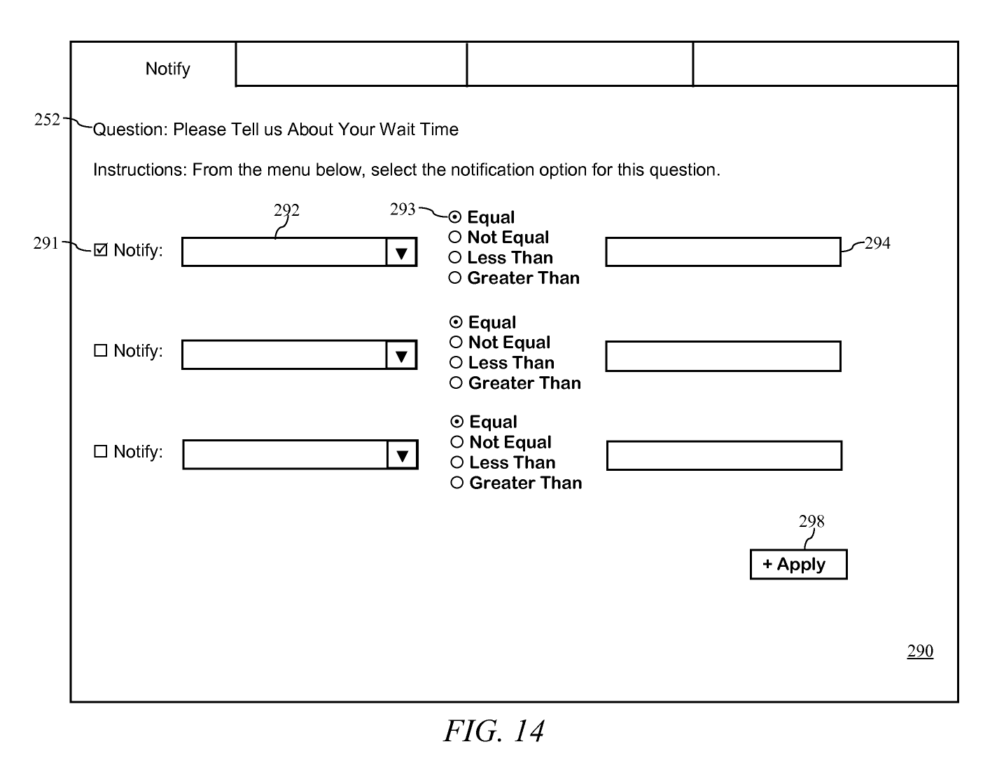

Referring to FIG. 14, a sample notification generator user interface screen for selecting specific questionnaire date that will invoke a notification of the present invention is shown. The notify user interface 290 has the survey question 252 and one or more (three in this example) possible notify scenarios. Each scenario is enabled by a check box 291 and, as in the filter of FIG. 13, has a target field 292, a comparison operator 293 and a value field 294. With this, the user/administrator is provided a mechanism to specify specific answers values that will trigger a notification event. Having such a tool, a manager (doctor, etc.) is able to immediately investigate what is happening and able to correct the situation before other customers (patients) are affected and/or is able to approach the disgruntled customer (patient) to try and appease the situation. For example, if the user/administrator creates a notify alarm for the question “tell us about your wait time,” and specifies doctor Smith 292 wants to receive notification if the respondent's wait time is equal to “unacceptable.”

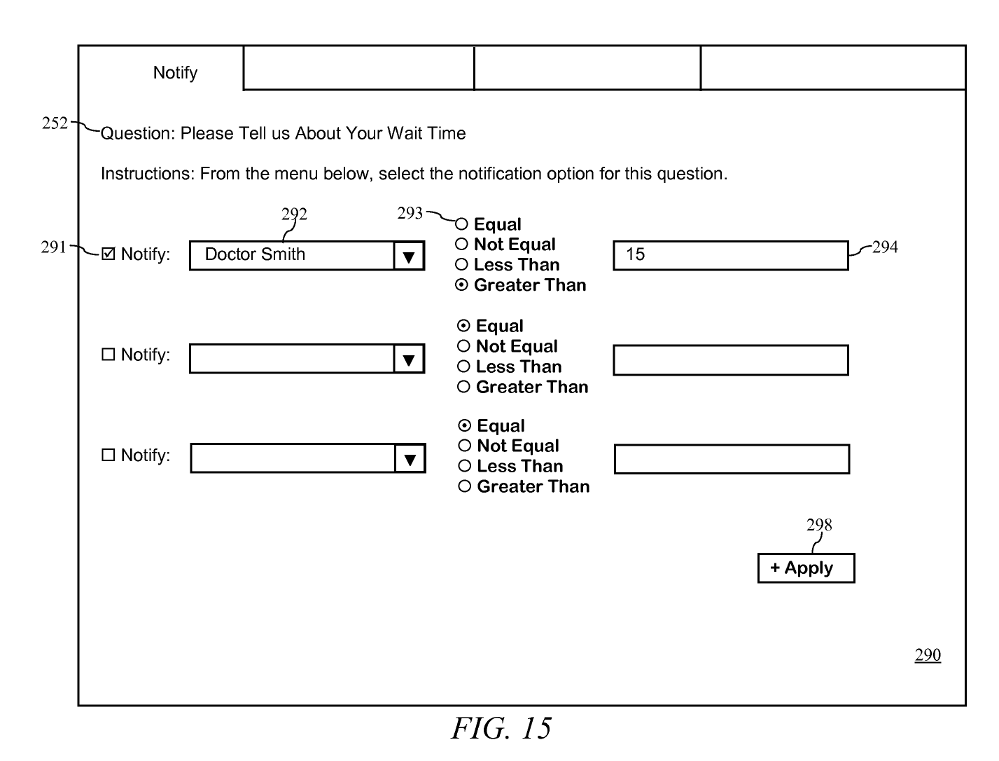

Referring to FIG. 15, a sample notification generator user interface screen for selecting specific questionnaire date that will invoke a notification of the present invention with data is shown. The notify user interface 290 has the survey question 252 and one or more (three in this example) possible notify scenarios. Each scenario is enabled by a check box 291 and, as in the filter of FIG. 13, has a target field 292, a comparison operator 293 and a value field 294. With this, the user/administrator is provided a mechanism to specify specific answers values that will trigger a notification event. In this example, the answer field is a numeric response (e.g., minutes of wait time). The user/administrator creates a notify alarm to notify Doctor Smith 292 if any respondents indicate a wait time greater than 293 15 minutes 294. In this example, Doctor Smith will receive near real-time notification(s) by the method selected (e.g., text message) each time a respondent enters a number greater than 15 minutes in the wait time field. Having such a tool, a manager (doctor, etc.) is able to immediately investigate what is happening and able to correct the situation before other customers (patients) are affected and/or is able to approach the disgruntled customer (patient) to try and appease the situation.

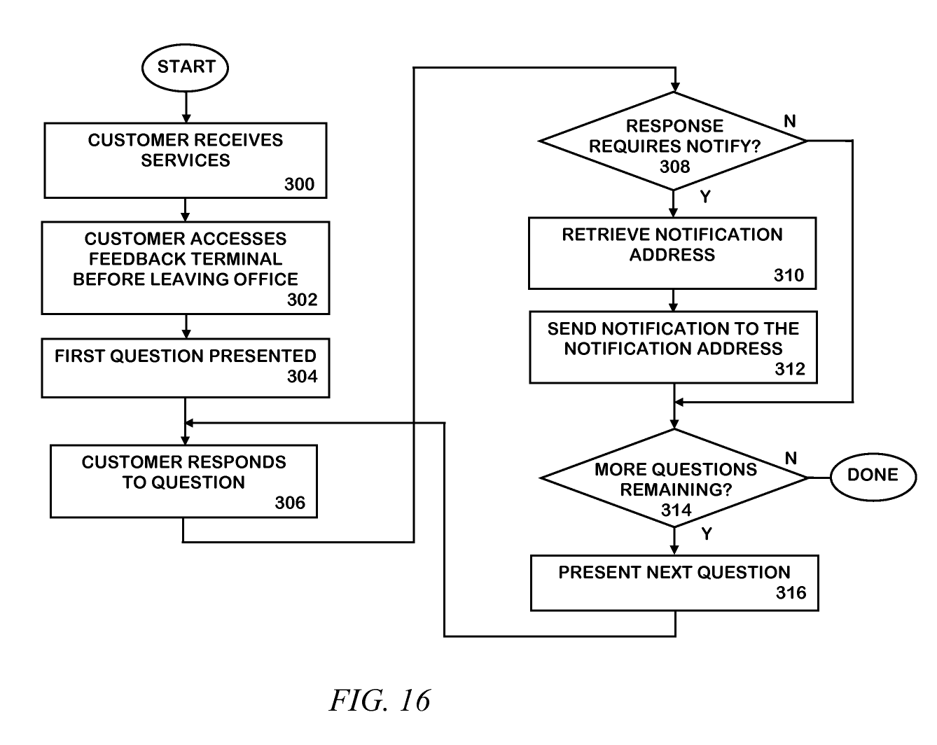

Referring to FIG. 16, a flow chart of the use of the present invention is shown. The process begins when a customer (or patient) visits an establishment and receives a service or product 300. For example, a patient visits a doctor's office and receives care. After receiving such service, the customer (patient) finds an easy-to-use survey terminal at a location where they would be comfortable to use such a device, for example, at the reception station, etc. The customer accesses the survey terminal 302. A first question is presented 304. The customer responds to the first question 306. If the customer's response indicates a very negative situation and the question was preprogrammed with a notify action, the response requires a notify event 308. The address of the notification target is retrieved 310 and the notification is sent 312 as described previously. If more questions remain, 314, the next question is presented 316 and the process continues until no more questions remain 314.

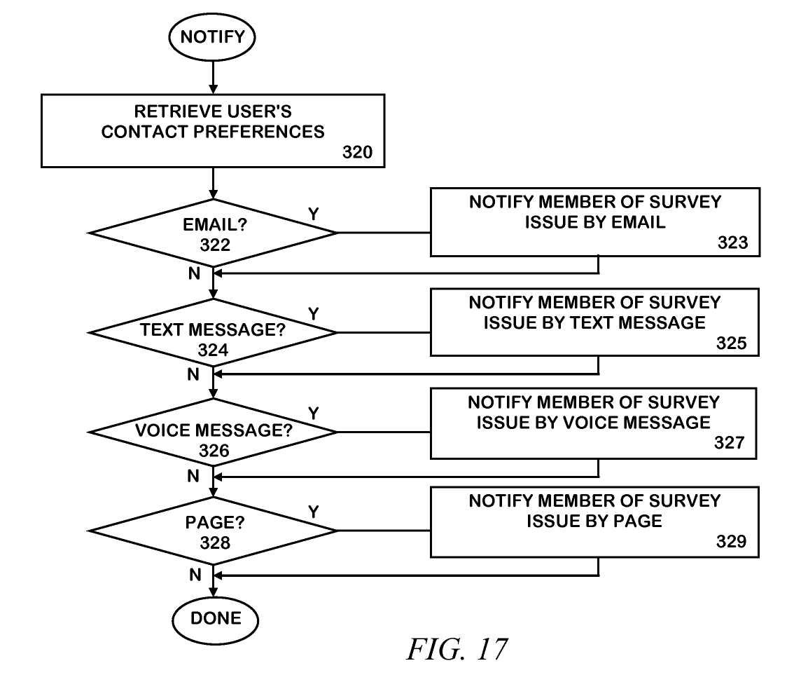

Referring to FIG. 17, a flow chart of the notification process of the present invention is shown. In this exemplary method of notifying a user of an unhappy respondent, the user's profile is consulted 320 to determine how the user is to be sent an alert message. It is assumed that the user has previously administered their profile with specifics regarding the method of transmitting the alert message. In this example, the data in the user's profile indicates whether the user desires email notification 322, text message notification 324, voice message notification 326 or a page notification 328. If the user desires email notification 322, the member is notified (sent an alert) by an email message 323 sent from the survey server 20, through the Internet 10 to the user's personal computer 17. If the user desires text message notification 324, the user is notified (sent an alert) by a text message sent 325 from the survey server 20, optionally through the Internet and through the cellular network 50 to the user's cell phone 13. If the user desires voice message notification 326, the user is notified (sent an alert) by a voice message sent 327 from the survey server 20, optionally through the Internet and through the cellular network 50 or plain old telephone network (not shown) to the user's phone or cell phone 13. In some embodiments, the voice message is pre-recorded while in other embodiments, the text message is created using text-to-speech or other methods known in the industry. If the user desires a page notification 328, the user is notified by a page sent 329 from the survey server 20, optionally through the Internet and through the paging network 55 to the user's pager 15.

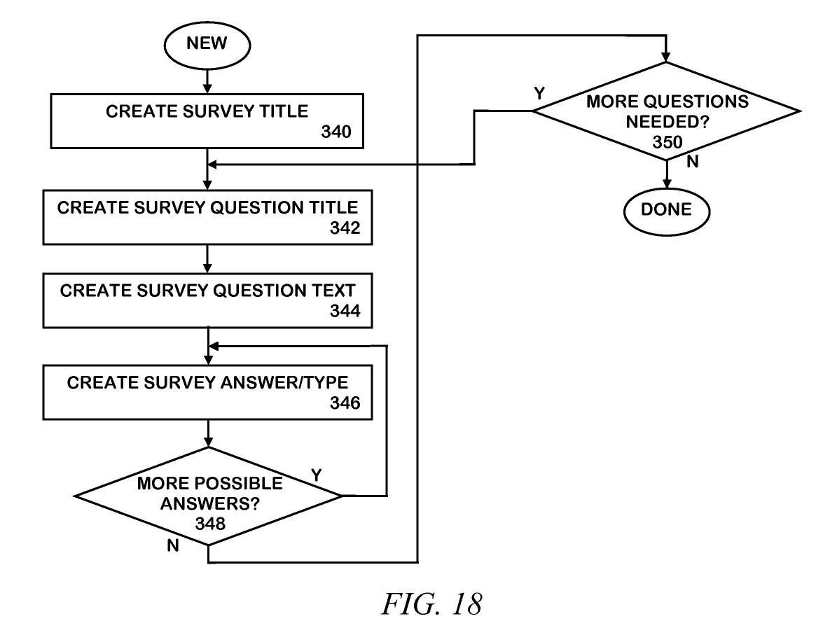

Referring to FIG. 18, a flow chart of the survey creation process of the present invention is shown. To create a new survey, the user/administrator provides a survey title 340, then for each survey question desired, the user provides a survey question title 342, the survey question text 344 and the survey answer type 346 (e.g., multiple choice). Then, if needed, the user provides text for each of the possible answers 348/349. When all of the answers are entered 348, it is determined if more questions are needed 350 and if so, the above steps are repeated to obtain each additional question and possible answers. Otherwise, if not more questions are needed 350, the process is done.

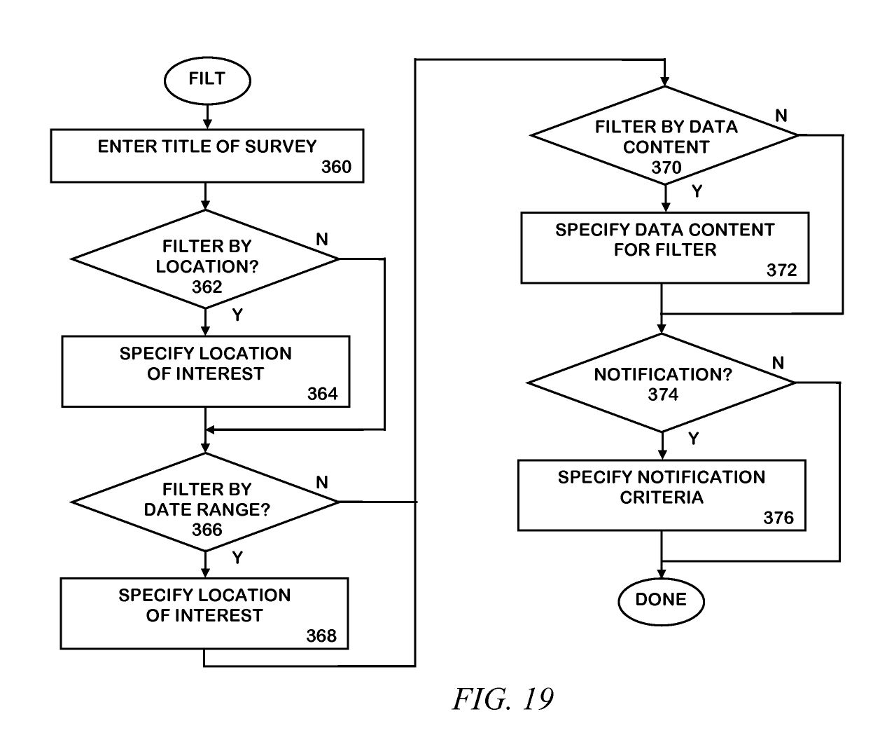

Referring to FIG. 19, a flow chart of the survey filter creation process of the present invention is shown. The user or administrator enters the title of the survey 360. If the user/administrator desires to filter by the location of the survey terminal 362, they specify the location(s) of the survey terminals 364. If the user/administrator desires to filter by a date range 366, they specify the date range desired 368. If the user/administrator desires to filter by content data 370, they specify the content data 372. If the user/administrator desires to create notification criteria 374, they specify the notification criteria 376. It is possible for the user/administrator to create Boolean notification criteria such as “(gender equals male and wait time greater than 10 minutes) or (gender equals female and wait time greater than 12 minutes).”

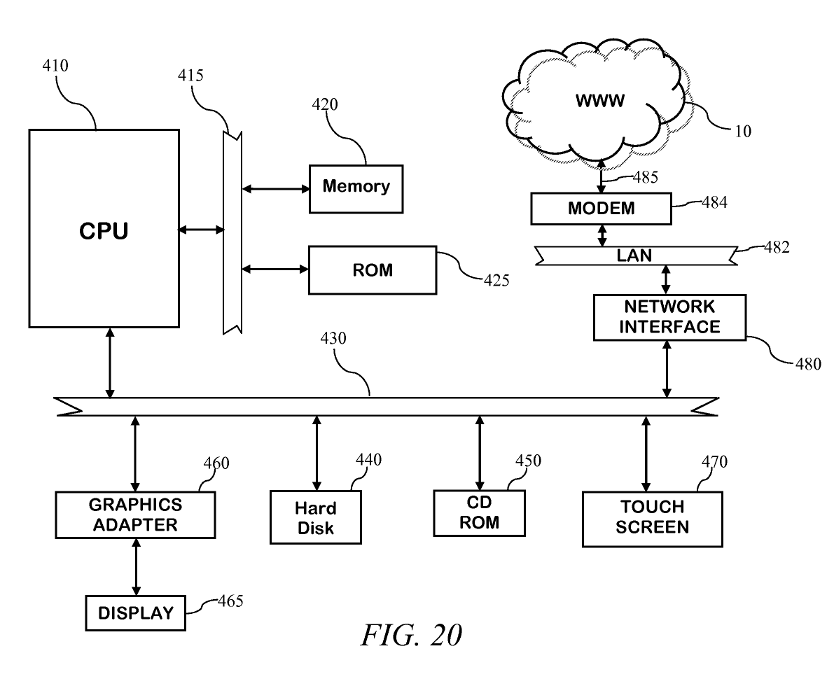

Referring to FIG. 20, a schematic diagram of a computer system of the present invention is shown. Although shown in its simplest form, having a single processor, many different computer architectures are known that accomplish similar results in a similar fashion and the present invention is not limited in any way to any particular computer system. The present invention works well utilizing a single processor system as shown in FIG. 20, a multiple processor system where multiple processors share resources such as memory and storage, a multiple server system where several independent servers operate in parallel (perhaps having shared access to the data or any combination). In this example, a processor 410 is provided to execute stored programs that are generally stored for execution within a memory 420. The processor 410 can be any processor or a group of processors, for example an Intel Pentium-4® CPU or the like. The memory 420 is connected to the processor by a memory bus 415 and can be any memory suitable for connection with the selected processor 410, such as SRAM, DRAM, SDRAM, RDRAM, DDR, DDR-2, etc. Firmware is stored in firmware storage 425 that is also connected to the processor 410 through the memory bus 415 and may include initialization software known as BIOS. This initialization software usually operates when power is applied to the system or when the system is reset.

Also connected to the processor 410 is a system bus 430 for connecting to peripheral subsystems such as a network interface 480, a hard disk 440, a CDROM 450, a graphics adapter 460 and a keyboard/mouse 470. The graphics adapter 460 receives commands and display information from the system bus 430 and generates a display image that is displayed on the display 465.

In general, the hard disk 440 may be used to store programs, executable code and data persistently, while the CDROM 250 may be used to load said programs, executable code and data from removable media onto the hard disk 440. These peripherals are meant to be examples of input/output devices, persistent storage and removable media storage. Other examples of persistent storage include core memory, FRAM, flash memory, etc. Other examples of removable media storage include CDRW, DVD, DVD writeable, compact flash, other removable flash media, floppy disk, ZIP®, etc. In some embodiments, other devices are connected to the system through the system bus 430 or with other input-output connections. Examples of these devices include printers; graphics tablets; joysticks; and communications adapters such as modems and Ethernet adapters.

The network interface 480 connects the computer-based system to a local area network 482. In some embodiments, the local area network 482 interfaces with a modem 484 such as a cable modem or a Digital Subscriber Loop (DSL) modem for accessing the Internet 10 through a data connection 485 (e.g., cable or phone line). The network 480 permits communication between survey terminals 24, survey servers 20 and administrative personal computers 17/37 and in some embodiments permits communications with the Internet 10 for remote access. In some embodiments, the local area network 482 is a wireless local area network such as Bluetooth and WiFi (e.g., 802.11).

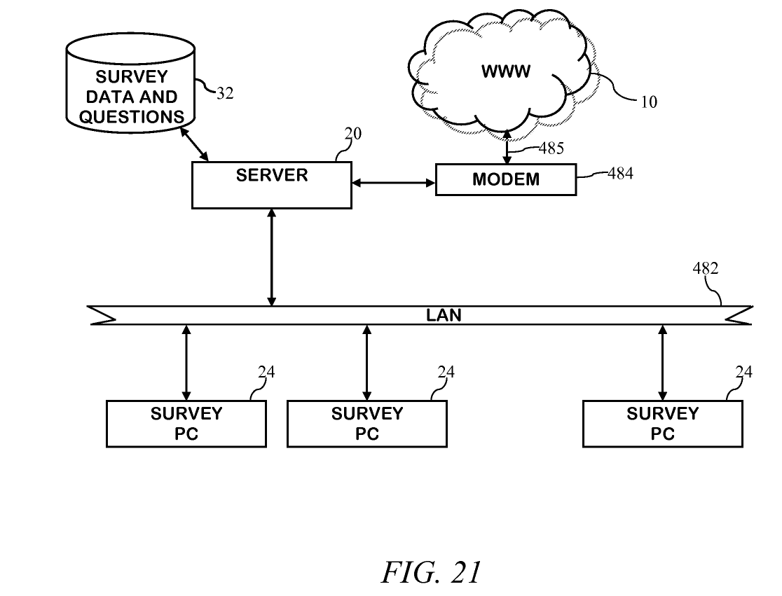

Referring to FIG. 21, a schematic diagram of an exemplary network system of the present invention is shown. In this exemplary network topology, the server 20 has a database of survey questions and data 32. The server is connected to a local area network 482, for example a wireless LAN or an Ethernet LAN. One or more survey terminals (personal computers) 24 are connected to the survey server 20 through the local area network 482 and communicate with the survey server 20 for obtaining current surveys and transmitting survey results back to the survey server 20. In some embodiments, one or more user/administrator personal computers 17 are also networked to the survey server 20 through the local area network 482. In some embodiments, the one or more user/administrator personal computers 17 are networked to the survey server 20 through the Internet 10 through a network connection 485 and a modem 484 (e.g., cable modem or DSL modem). In some embodiments, as shown, the modem 484 is directly connected to the survey server 20. In alternate embodiments, the modem 484 is connected to the server through the local area network 482 as shown in FIG. 20.

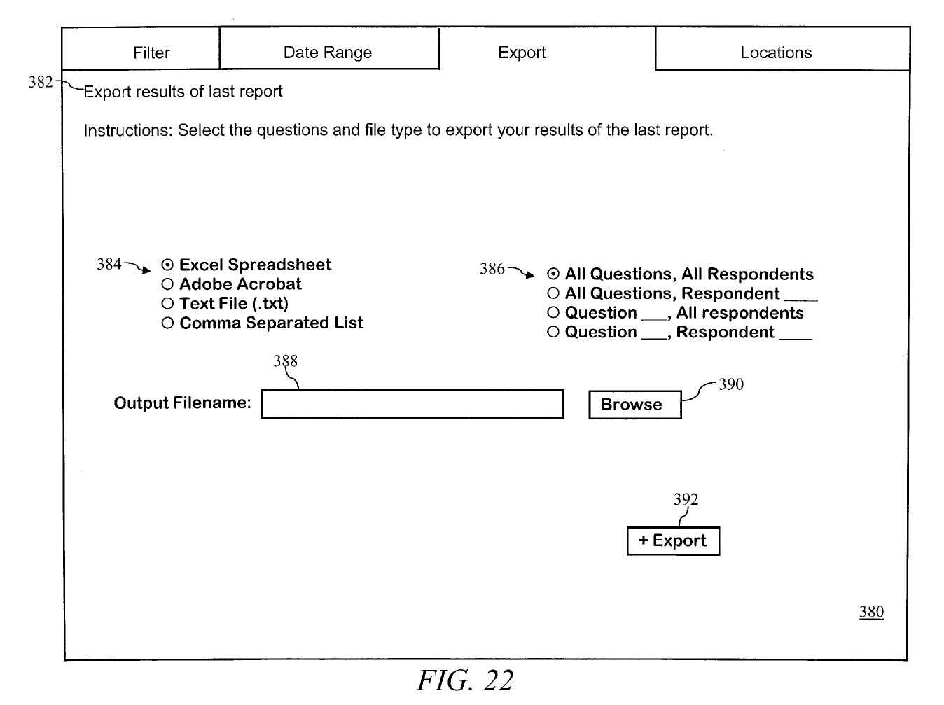

Referring to FIG. 22, a sample data export user interface screen of the present invention is shown. In this exemplary user interface 380, features are provided to permit the user to select an output file format 384 and a filter of the type of output to export 386. The user selects an output format 384 such as an Excel Spreadsheet as selected by the radio button and what parts of the report to export 386, such as all questions from all respondents as selected by this radio button. If the user selects a specific respondent or a specific question 386, the user enters an identification of the respondent or question into the provided blank(s) 386. The user specifies an output file name 388 or browses 390 to find an existing output file or directory. Once this is complete, the user selects the export icon 392 to export the desired data to the specified output file.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A method of obtaining feedback at a location of service, the method comprising:
providing a computer terminal device located at a location of service;
presenting a plurality of survey questions at the computer terminal device, at least one of the survey questions having an answer value configured to trigger a notification signal;
inputting at least one response to the survey questions at the computer terminal device; and
if any one of the at least one responses includes the answer value configured to trigger the notification signal, generating the notification signal.

2. The method of obtaining feedback at a location of service of claim 1, further comprising the step of processing the notification signal, the processing including in response to the notification signal, determining a user preference for receiving an alert and sending the alert using a means for transmitting the alert indicated by the user preference.

3. The method of obtaining feedback at a location of service of claim 2, wherein the means for transmitting is selected from the group consisting of transmitting an email message, transmitting a page message, transmitting a text message sent to a cell phone and transmitting a voice message sent to a phone.

4. The method of obtaining feedback at a location of service of claim 1, wherein the computer terminal device is a touch screen monitor.

5. The method of obtaining feedback at a location of service of claim 1, further comprising a software system for authoring a survey, the survey including the survey questions.

6. The method of obtaining feedback at a location of service of claim 5, wherein the software system for authoring the survey includes a means for specifying one or more of the answer values configured to trigger the notification signal.

7. The method of obtaining feedback at a location of service of claim 6, wherein the software system for authoring the survey includes a means for generating reports of completed surveys.

8. The method of obtaining feedback at a location of service of claim 7, wherein the reports of the completed surveys are filtered by the location of service.

9. A method of obtaining feedback at a location of service, the method comprising:
providing a touch screen computer terminal device located at a location of service;
presenting a plurality of survey questions at the touch screen computer terminal device, at least one of the survey questions having a means for triggering a notification signal responsive to an answer to the at least one survey question; and
inputting at least one response to the at least one survey question at the touch screen computer terminal device.

10. The method of obtaining feedback at a location of service of claim 9, further comprising the step of processing the notification signal, the processing including a means for determining a user preference for receiving an alert and sending the alert using a means for transmitting the alert as indicated by the user preference, responsive to the notification signal.

11. The method of obtaining feedback at a location of service of claim 10, wherein the means for transmitting the alert is selected from the group consisting of transmitting an email message, transmitting a page message, transmitting a text message sent to a cell phone and transmitting a voice message sent to a phone.

12. The method of obtaining feedback at a location of service of claim 9, further comprising a software system for authoring a survey, the survey including the survey questions.

13. The method of obtaining feedback at a location of service of claim 12, wherein the software system for authoring the survey includes a means for specifying the notification signal responsive to the answer to the survey question.

14. The method of obtaining feedback at a location of service of claim 12, wherein the software system for authoring the survey includes a means for generating reports of completed surveys.

15. The method of obtaining feedback at a location of service of claim 14, wherein the reports of the completed surveys are filtered by the location of service.

16. A computer system for obtaining feedback at a location of service, the method comprising:
at least one touch screen computer terminal device located at a location of service;
a computer software module for authoring a survey, the survey comprising a plurality of survey questions, at least one of the survey questions having an answer value configured to trigger a notification signal;
a computer software module for presenting the survey at the at least one touch screen computer terminal and for obtaining respondent answers to the survey questions; and
a computer software module that monitors the respondent answers and if any of the respondent answers have the answer value configured to trigger the notification signal, the computer software module that monitors the respondent answers triggers the notification signal.

17. The computer system for obtaining feedback at a location of service of claim 16, further comprising a software module that determines a user preference for receiving an alert and sends the alert to a user responsive to the notification signal.

18. The computer system for obtaining feedback at a location of service of claim 17, wherein the alert is sent by a transmission selected from the group consisting of an email message transmission, a page message transmission, a text message transmission to a cell phone and a voice message transmission to a phone.

19. The computer system for obtaining feedback at a location of service of claim 16, further comprising a software module for authoring the survey.

20. The computer system for obtaining feedback at a location of service of claim 19, wherein the software module for authoring the survey includes a means for specifying one or more of the answer values configured to trigger the notification signal.

21. The computer system for obtaining feedback at a location of service of claim 19, wherein the software module for authoring the survey includes a means for generating reports of completed surveys.

22. The computer system for obtaining feedback at a location of service of claim 21, wherein the software module for authoring the survey includes a means for filtering by the location of service.
